(19) United States
(12) Patent Application Publication
(10) Pub. No.: US 2017/0270165 A1
(43) Pub. Date: Sep. 21, 2017

(54) DATA STREAMING BROADCASTS IN MASSIVELY PARALLEL PROCESSING DATABASES

(71) Applicant: Futurewei Technologies, Inc., Plano, TX (US)

(72) Inventor: Yu Dong, San Jose, CA (US)

(21) Appl. No.: 15/071,712

(22) Filed: Mar. 16, 2016

(51) Int. Cl. G06F 17/30; H04L 29/06

(52) U.S. Cl. CPC G06F 17/30516; H04L 65/60

(57) ABSTRACT

A method comprises, by a first node on a first server in a massively parallel processing (MPP) database, selecting a second node on a second server in the MPP database. The first server further transmits data from the first node to the second node over a network. The method further comprises providing the data from the second node to other nodes on the second server.

### TECHNICAL FIELD

Embodiments of the present disclosure relate generally to data processing and, more particularly, but not by way of limitation, to methods and systems for data streaming broadcasts in massively parallel processing databases.

### BACKGROUND

Conventionally, data streaming broadcasts in massively parallel processing (MPP) databases are broadcast from the generating node to every other node in the system.

### SUMMARY OF THE INVENTIVE SUBJECT MATTER

In some example embodiments, what is disclosed is a method comprising: by a first node on a first server in an MPP database, selecting a second node on a second server in the MPP database; transmitting data from the first node to the second node over a network; and providing the data from the second node to other nodes on the second server.

In some example embodiments, what is disclosed is a system comprising: a first server in an MPP database and a second server in the MPP database, wherein the first server comprises: a memory having instructions embodied thereon; and one or more processors configured by the instructions to perform steps comprising: by a first node, selecting a second node on the second server; transmitting data from the first node to the second node over a network; and the second server comprises: a memory having instructions embodied thereon; and one or more processors configured by the instructions to perform steps comprising: providing the data from the second node to other nodes on the second server.

In some example embodiments, what is disclosed is a machine-readable medium not having any transitory signals and having instructions embodied thereon which, when executed by one or more processors of a machine, cause the machine to perform steps comprising: receiving, from a master host of an MPP database, an instruction to broadcast data to a plurality of nodes on a server of the MPP database; responsive to the received instruction, selecting a node of the plurality of nodes; transmitting the data to the node; and refraining from transmitting the data to other nodes of the plurality of nodes.

### BRIEF DESCRIPTION OF THE DRAWINGS

Various ones of the appended drawings merely illustrate example embodiments of the present disclosure and cannot be considered as limiting its scope.

FIG. 1 is a communication diagram illustrating communications between a database server, a coordinator server, and another database server in implementing data streaming broadcasts in massively parallel processing databases, according to the prior art.

FIG. 2 is a block diagram illustrating a networked system suitable for data streaming broadcasts in massively parallel processing databases, according to some example embodiments.

FIG. 3 is a block diagram illustrating devices of a computer system suitable for data streaming broadcasts in massively parallel processing databases, according to some example embodiments.

FIG. 4 is a block diagram illustrating devices of a computer system suitable for data streaming broadcasts in massively parallel processing databases, according to some example embodiments.

FIG. 5 is a communication diagram illustrating communications between a database server, a coordinator server, and another database server in implementing data streaming broadcasts in massively parallel processing databases, according to some example embodiments.

FIG. 6 is a flow diagram illustrating steps performed by a computer system suitable for data streaming broadcasts in massively parallel processing databases, according to some example embodiments.

FIG. 7 is a flow diagram illustrating steps performed by a computer system suitable for data streaming broadcasts in massively parallel processing databases, according to some example embodiments.

FIG. 8 is a flow diagram illustrating performed by a computer system suitable for supporting data streaming broadcasts in massively parallel processing databases, according to some example embodiments.

FIG. 9 is a block diagram illustrating circuitry for clients, servers, cloud based resources for implementing algorithms and performing methods according to example embodiments.

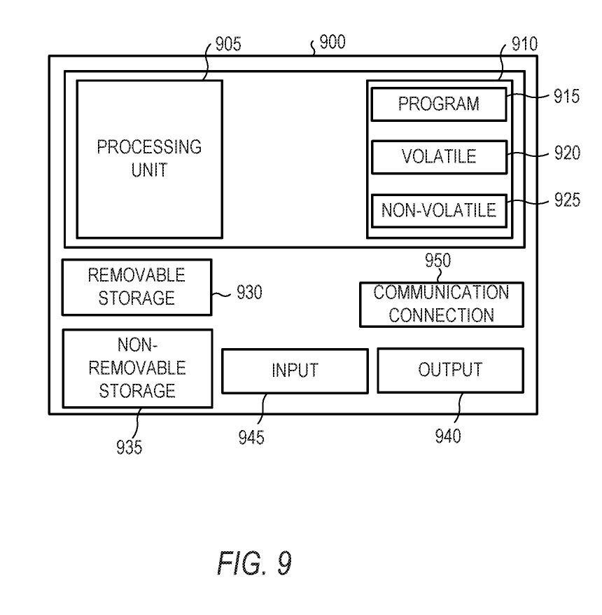

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

An MPP database uses a plurality of database servers to divide storage and access of data in the database. This often reduces the time needed to execute database instructions. For example, in an MPP database with two servers, the records of a database table may be divided evenly between the two servers. Accordingly, a query for a record in the table may be executed by both servers in parallel, with each search evaluating half of the data compared to a single server database evaluating all of the data. As a result, the query is completed more quickly than by a non-MPP database.

Each database server in the MPP database hosts a plurality of nodes. Each node is an independent instance of the database software that accesses a distinct portion of the database. By using more than one node per server, multiple processors on the server can be used more efficiently.

A query that depends on a comparison between values in two tables may trigger a broadcast of data. For example, the query “SELECT* from R, S where R.a=S.a” should return all rows of R and S that have an “a” value that is also an “a” value in the other table. In the worst case, to complete the query, the “a” value of every row in R must be compared to the “a” value of every row in S.

In a MPP database, no database server will contain all of either R or S. Accordingly, some data will have to be transmitted between the database servers in order to complete the query. This may be accomplished by a broadcast join, which transfers all parts of one table (e.g., table R) to all database nodes on all database servers.

After the broadcast, each node will have access to all rows of the broadcast table, and thus will be able to compare the complete set of R.a values to the S.a values stored on the database server. By aggregating the results obtained from each database server, the result of the query is generated. The aggregation may be performed by a separate coordinator server. In some example embodiments, one or more of the database servers also serves as a coordinator server.

In some example embodiments, the broadcast data is transmitted to only a single node on each server. The recipient node provides the broadcast data to other nodes on the same server (e.g., through shared memory). By avoiding transmission to each node over a network connection and using faster, same-server communication methods instead, processing time may be reduced and throughput increased.

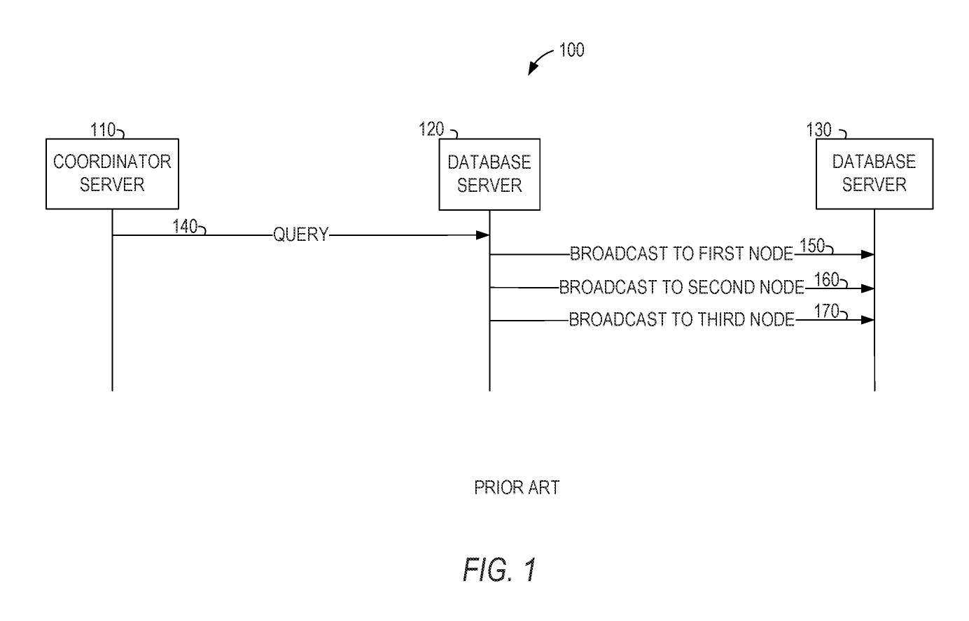

FIG. 1 is a communication diagram 100 illustrating communications between a coordinator server 110, a database server 120, and a database server 130 in implementing a prior art solution for broadcasting data in an MPP database. In communication 140, a query plan is transmitted from the coordinator server 110 to the database server 120. In response to receiving the communication 140, the database server 120 determines that a broadcast of data from a node on the database server 120 to a plurality of nodes on the database server 130 should be performed. Accordingly, communications 150-170 carry the broadcast data from the node on the database server 120 to each of three nodes on the database server 130.

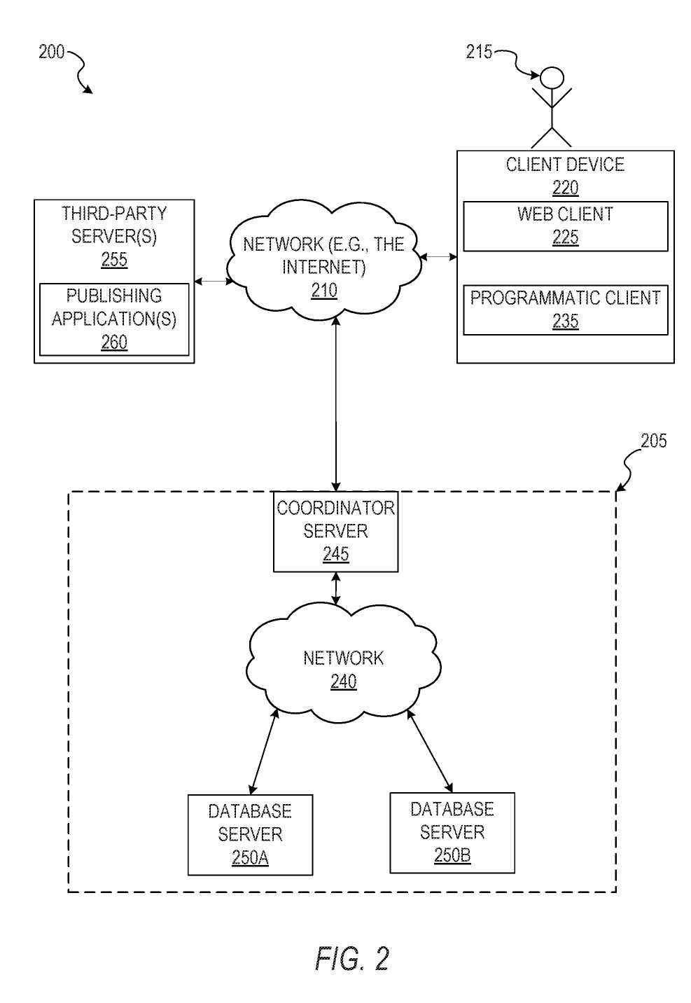

With reference to FIG. 2, an example embodiment of a high-level client-server-based network architecture 200 is shown. The network architecture 200 includes a networked system 205, a network 210, one or more client devices 220, and one or more third-party servers 255. The networked system 205 includes, in some examples, a coordinator server 245, a network 240, and one or more database servers 250. The networked system 205 provides server-side functionality via the network 210 (e.g., the Internet or wide area network (WAN)) to the one or more client devices 220.

The one or more client devices 220 access the network 210 and may access the networked system 205 via the network 210, such as for interacting with the one or more database servers 250 of the networked system 205. The client device 220 may include applications that are employed by a user 215. FIG. 2 illustrates, for example, a web client 225 (e.g., a browser, such as the Internet Explorer® browser developed by Microsoft® Corporation of Redmond, Wash. State), and a programmatic client 235 executing on the client device 220. The web client 225 and the programmatic client 235 can be employed by the user 215 to access the networked system 205 and store or retrieve information from the one or more database servers 250.

The client device 220 may comprise, but is not limited to, a mobile phone, desktop computer, laptop, portable digital assistant (PDA), smart phone, tablet, ultra book, netbook, multi-processor system, microprocessor-based or programmable consumer electronics, or any other communication device that a user may utilize to access the networked system 205. In some embodiments, the client device 220 may comprise a display device (not shown) to display information (e.g., in the form of user interfaces). The client device 220 may be a device of a user that is used to receive one or more signed messages. In one embodiment, the networked system 205 is a network-based MPP database. One or more portions of the network 210 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

Each client device 220 may include one or more applications (also referred to as “apps”) such as, but not limited to, a web browser, a messaging application, an electronic mail (email) application, and the like.

The one or more users 215 may be persons, machines, or other means of interacting with the client device 220. In example embodiments, the user 215 is not part of the network architecture 200, but may interact with the network architecture 200 via the client device 220 or other means. For instance, the user provides input (e.g., touch screen input or alphanumeric input) to the client device 220 and the input is communicated to the networked system 205 via the network 210. In this instance, the networked system 205, in response to receiving the input from the user, communicates information to the client device 220 via the network 210 to be presented to the user. In this way, the user can interact with the networked system 205 using the client device 220.

The coordinator server 245 is coupled to the network 210 for communication with the third-party server 255 and the client device 220. The coordinator server 245 provides an application program interface (API) for interfacing with the programmatic client 235 and a web interface for interfacing with the web client 225. The coordinator server 245 provides access to the MPP database of the networked system 205. The coordinator server 245 communicates with one or more database servers 250 (labeled as database server 250A and database server 250B in FIG. 2 and referred to collectively as database servers 250 or singularly as a database server 250) via a network 240. Each database server 250 stores a portion of the MPP database. The coordinator server 245 processes queries to create a query plan and communicates the query plan (or appropriate portions thereof) to the database servers 250. The database servers 250 process the corresponding portions of the query plan and return the partial results to the coordinator server 245. After combining the partial results, the coordinator server 245 provides the results to the client device 220 or the third-party server 255 in response to the received query. In some example embodiments, one or more of the database servers 250 also serves as a coordinator server 245. Multiple coordinator servers may be used. In some example embodiments, incoming queries are received by a load balancer that divides the queries between the plurality of coordinator servers (either stand-alone or integrated with database servers).

Additionally, one or more publishing applications 260, communicating with or integrated into third-party servers 255, are shown as having programmatic access to the networked system 205 via the programmatic interface provided by the coordinator server 245. For example, the third-party server 255 receives information from the MPP database via the network 210.

Further, while the client-server-based network architecture 200 shown in FIG. 2 employs a client-server architecture, the present inventive subject matter is, of course, not limited to such an architecture, and could equally well find application in a distributed, or peer-to-peer, architecture system, for example.

The web client 225 may access the MPP database via the web interface supported by the coordinator server 245 and the publishing applications 260 via a web interface supported by the third-party servers 255. Similarly, the programmatic client 235 accesses the various services and functions provided by the MPP database via the programmatic interface provided by the coordinator server 245.

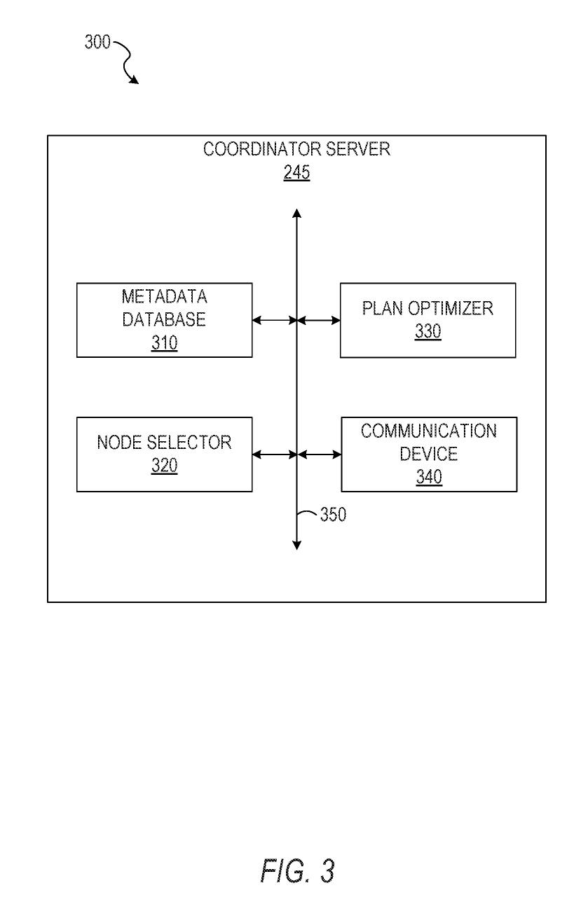

FIG. 3 is a block diagram 300 illustrating devices of a coordinator server 245 suitable for hosting an MPP database, according to some example embodiments. Devices may be hardware modules. A “hardware module” is a tangible unit capable of performing certain steps and may be configured or arranged in a certain physical manner In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain steps as described herein. As shown in FIG. 3, the coordinator server 245 includes a metadata database 310, a node selector 320, a plan optimizer 330, and a communication device 340, coupled by a bus or communication link 350. In some example embodiments, the devices of the coordinator server 245 are combined into a single hardware module. In other example embodiments, features of the disclosed devices are divided into more or fewer hardware modules.

The metadata database 310 stores metadata for the MPP. For example, as discussed above, the data tables of the MPP are divided among the various database servers 250 of the MPP. To reliably access the data, the coordinator server 245 stores metadata showing which portions of the data tables are stored on each of the database servers 250.

The node selector 320, in some example embodiments, selects nodes to receive broadcast data. For example, the coordinator server 245 may receive a query from a client device (e.g., the client device 220) and, responsive to the query, generate a query plan using the plan optimizer 330. The query plan generated by the plan optimizer 330 often divides the work for the query between several database servers 250. Accordingly, each tasked database server 250 performs a portion of the query and returns the partial results to the coordinator server 245. The coordinator server 245 combines the partial results and provides them to the requesting device.

The query plan may include having one or more database nodes broadcast data to all other servers in the MPP. The recipient node for the broadcast on one or more of the receiving servers can be selected by the node selector 320. For example, a random node on the receiving server can be selected, a least-busy node on the receiving server can be selected, a least-recently-selected node on the receiving server can be selected, or any suitable combination thereof.

The communication device 340 is configured to communicate with external devices. The communication device 340 sends data to and receives data from other systems (e.g., the systems shown in FIG. 2). For example, the communication device 340 may receive data from the third-party servers 255, the client device 220, and the database servers 250; send data to the third-party servers 255, the client device 220, and the database servers 250; or any suitable combination thereof. The communication device 340 may be programmable to allow a variety of communication protocols to be implemented. For example, Java®, C, or C++ may be used to program the communication device 340. Example physical devices to implement the communication device 340 include a plug-in card, a USB-connected device, a modem, a network adapter, a configured central processing unit (CPU) or graphics processing unit (GPU), or any suitable combination thereof.

In some example embodiments, communications received by the communication device 340 cause the display of a user interface on the client device 220. For example, the communication device 340 may transmit a web page for a web browser of the client device 220. The web browser parses the web page to generate a user interface on the client device 220, for display to the user 215.

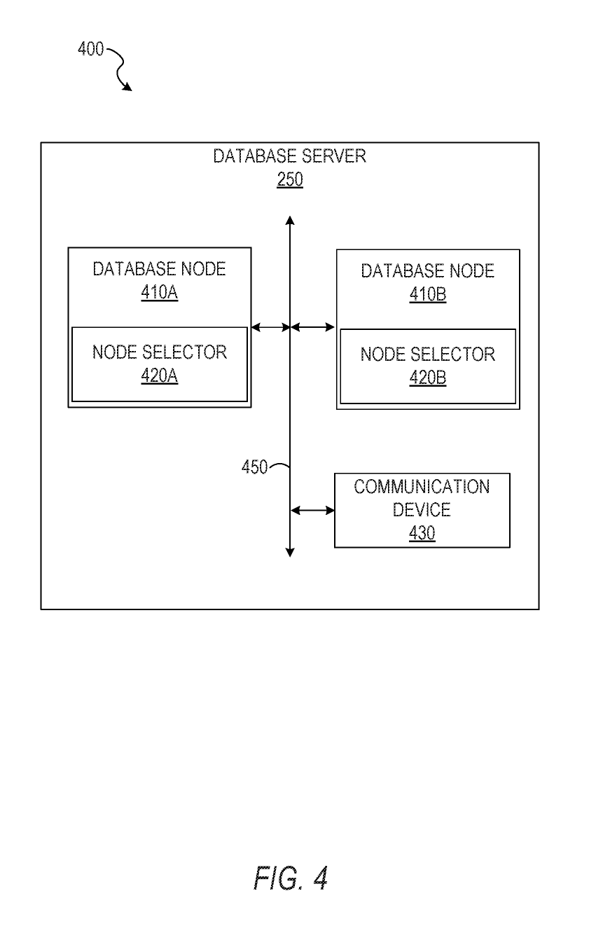

FIG. 4 is a block diagram 400 illustrating devices of a database server 250 suitable for providing data streaming broadcasts in MPP databases, according to some example embodiments. As shown in FIG. 4, the database server 250 includes database nodes 410A and 410B (collectively referred to as database nodes 410 or individually as a database node 410), corresponding node selectors 420A and 420B (collectively referred to as node selectors 420 or individually as a node selector 420), and a communication device 430, coupled by a bus or communication link 450.

The database nodes 410 access data stored on physical storage devices (e.g., hard disks, random access memory (RAM) chips, optical storage devices, or any suitable combination thereof) to satisfy queries provided by the coordinator server 245. A database node 410 (e.g., the database node 410A) on a particular database server 250 (e.g., the database server 250A) may receive broadcast data from a database node on another database server 250 (e.g., the database server 250B). The received broadcast data may be useful in completing a query received from the coordinator server 245. The received broadcast data may be provided to other nodes on the database server 250 (e.g., to the database node 410B) using a high-speed communication method within the database server 250 (e.g., a shared memory). Similarly, a database node 410 may broadcast data to nodes on other database servers 250.

A node selector 420 selects, in some example embodiments, a node on each recipient system of a broadcast. For example, a random node on each recipient system can be selected. Accordingly, the broadcast data for each recipient system will be addressed to, and processed by, the selected node.

The communication device 430 sends data to and receives data from other systems (e.g., the systems shown in FIG. 2). For example, the communication device 430 may receive data from the coordinator server 245, third-party servers 255, and client device 220; send data to the coordinator server 245, third-party servers 255, and client device 220; or any suitable combination thereof. The communication device 430 may be programmable to allow a variety of communication protocols to be implemented. For example, Java®, C, or C++ may be used to program the communication device 430. Example physical devices to implement the communication device 430 include a plug-in card, a USB-connected device, a modem, a network adapter, a configured central processing unit (CPU) or graphics processing unit (GPU), or any suitable combination thereof.

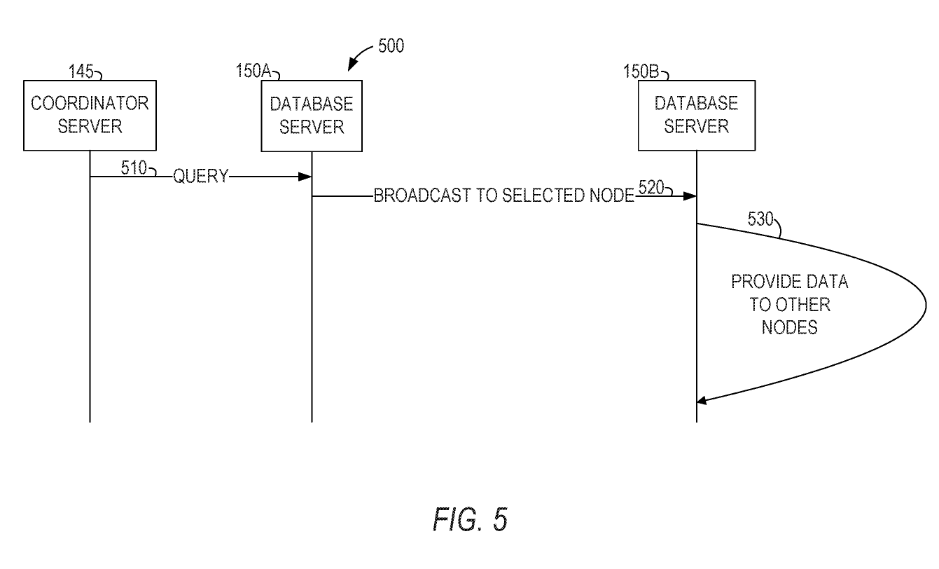

FIG. 5 is a communication diagram 500 illustrating communications between the coordinator server 245, the database server 250A, and the database server 250B broadcasting data in an MPP database, according to some example embodiments. In communication 510, a query is transmitted from the coordinator server 245 to the database server 250A. In response to receiving the communication 510, the database server 250A determines that a broadcast of data from a node on the database server 250A to a plurality of nodes on the database server 250B should be performed. Accordingly, communication 520 carries the broadcast data from the node on the database server 250A to a selected node on the database server 250B. The selected node on the database server 250B provides the broadcast data, via communication 530, to other nodes on the database server 250B.

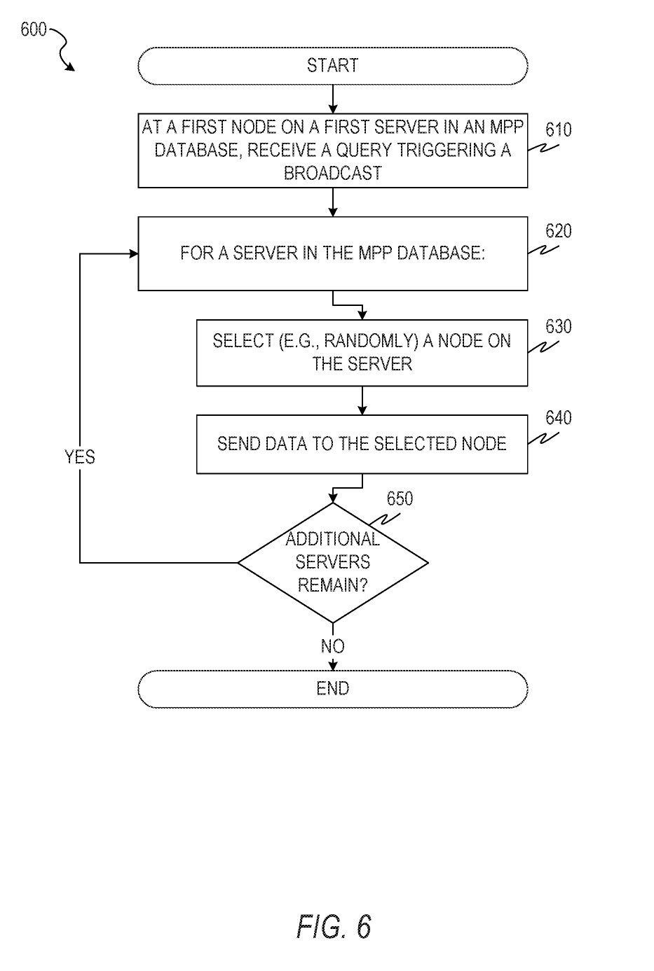

FIG. 6 is a flow diagram illustrating steps of a computer system implementing a process 600 suitable for broadcasting data in an MPP database, according to some example embodiments. By way of example and not limitation, the steps of the process 600 are described as being performed by the devices of FIG. 4.

In step 610, a first node (e.g., the database node 410A) on a first server (e.g., the database server 250A) in an MPP database receives a query triggering a broadcast. For example, if the coordinator server 245 receives a query such as “SELECT R.* from R, S where R.a=S.a” and S is the smaller table, the database server 250A may be instructed to broadcast the portion of S stored on the database server 250A to all other database servers 250 in the MPP database.

In step 620, a loop is begun, which causes steps 630 and 640 to be performed for each other database server 250 in the MPP database. The node selector 420 selects a node on the other database server 250 (step 630) and the communication device 430 sends the broadcast data to the selected node (step 640). In some example embodiments, the destination node is selected randomly. The process is repeated until all other database servers in the MPP database have been processed (step 650).

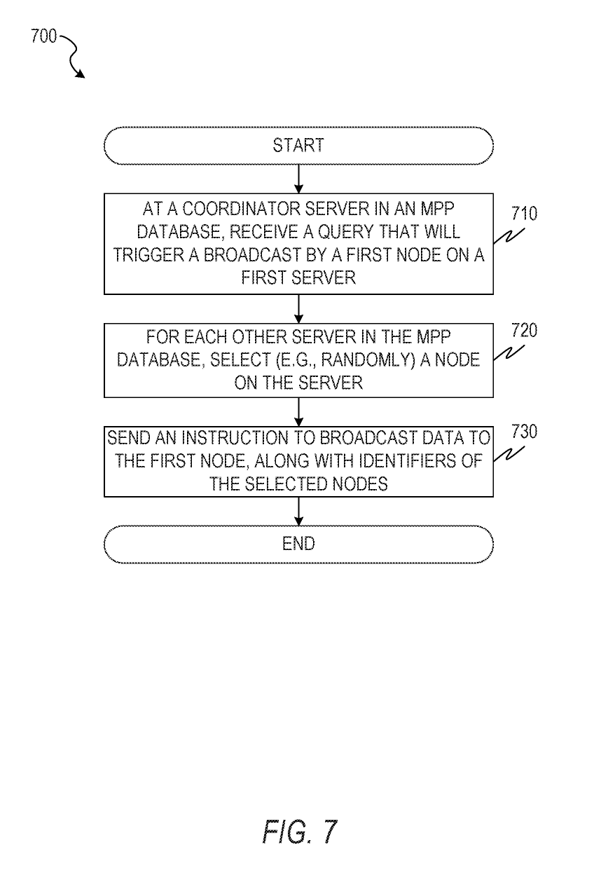

FIG. 7 is a flow diagram illustrating steps of a computer system implementing a process 700 suitable for data streaming broadcasts in MPP databases, according to some example embodiments. By way of example and not limitation, the steps of the process 700 are described as being performed by the devices of FIG. 3.

In step 710, a host server (e.g., the coordinator server 245) in an MPP database receives a query that will trigger a broadcast by a first node on a first database server (e.g., the database node 410A of the database server 250A). For example, a query may be received that will be processed by having one node on each database server broadcast the portion of a table S stored on that database server to all other servers.

The node selector 320 of the coordinator server 245 selects a node on each database server 250 other than the one broadcasting the data (step 720). For example, a random node on each database server 250 may be selected. Other selection methods may also be used. For example, in some example embodiments a counter tracks the number of broadcasts received by each node on each server. The node on each server having the lowest current counter value is selected to receive the broadcast and the counter for that node is incremented. In this manner, over a period of time, each node on the server will be selected to receive the same number of broadcasts. Another method of achieving essentially the same effect is to maintain a reference to the previously-selected node for each server. As each broadcast node is selected, the reference is updated to refer to the next node on the server, wrapping back to the first node once all nodes have been selected. In some example embodiments, a random selection is preferred over a round-robin selection to avoid the possibility of negative synchronicity. For example, if there are 15 nodes on each server and an application is running such that every 15^{th} broadcast is substantially larger than the other 14, then the same node will be selected to receive every large broadcast. A random selection avoids the negative synchronicity problem.

In step 730, the communication device 340 transmits an instruction to the database node 410A of the database server 250A to broadcast the data to the selected nodes on the other database servers 250. In response to receiving the instruction, the communication device 430 of the database server 250A transmits the data to the selected node on each database server 250.

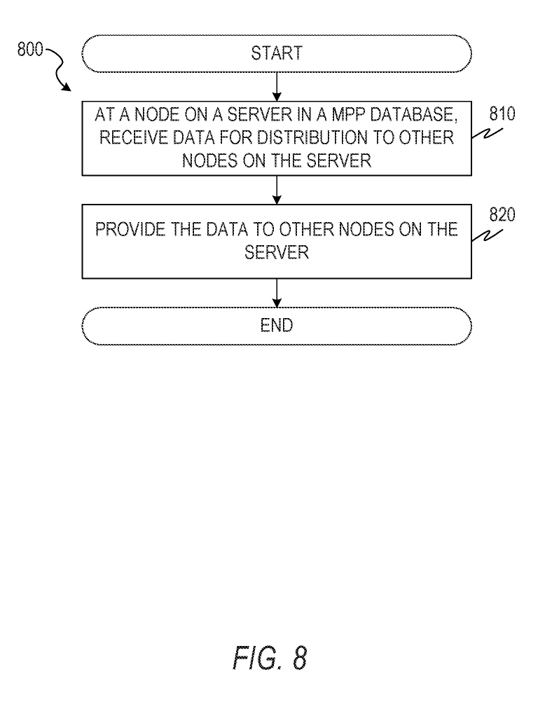

FIG. 8 is a flow diagram illustrating steps of a computer system implementing a process 800 suitable for data streaming broadcasts in MPP databases, according to some example embodiments. By way of example and not limitation, the steps of the process 800 are described as being performed by the devices of FIG. 4.

In step 810, a node on a database server (e.g., the node 410A of the database server 250B) receives data for distribution to other nodes on the server. For example, the data broadcast in step 640 may be received by the node 410 of the server 250B.

In step 820, the receiving node provides the received data to one or more other nodes (e.g., all other nodes) on the server. For example, this may be accomplished by storing the received data in a shared memory accessible by the other nodes. Other alternatives include the use of inter-process communications (IPC) such as a UNIX-domain socket, a message queue, a pipe, or a signal. In some example embodiments, the data is provided by the receiving node writing data to a work file, which is then read by other nodes on the same server to access the data. Notification from one node to the other that data is ready for accessing is, in some example embodiments, accomplished through the use of semaphores.

### Modules, Components, and Logic

The various steps of example methods described herein may be performed, at least partially, by one or more processors that are temporarily configured (e.g., by software) or permanently configured to perform the relevant steps. Whether temporarily or permanently configured, such processors may constitute processor-implemented modules that operate to perform one or more steps or functions described herein. As used herein, “processor-implemented module” refers to a hardware module implemented using one or more processors.

Similarly, the methods described herein may be at least partially processor-implemented, with a particular processor or processors being an example of hardware. For example, at least some of the steps of a method may be performed by one or more processors or processor-implemented modules. Moreover, the one or more processors may also operate to support performance of the relevant steps in a “cloud computing” environment or as a “software as a service” (SaaS). For example, at least some of the steps may be performed by a group of computers (as examples of machines including processors), with these steps being accessible via a network (e.g., the Internet) and via one or more appropriate interfaces (e.g., an Application Program Interface (API)).

The performance of certain of the steps may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-8 are implemented in some embodiments in the context of a machine and an associated software architecture. The sections below describe representative software architecture(s) and machine (e.g., hardware) architecture(s) that are suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the invention in different contexts from the disclosure contained herein.

One example computing device in the form of a computer 900 may include a processing unit 905, memory 910, removable storage 930, and non-removable storage 935. Although the example computing device is illustrated and described as computer 900, the computing device may be in different forms in different embodiments. Further, although the various data storage elements are illustrated as part of the computer 900, the storage may also or alternatively include cloud-based storage accessible via a network, such as the Internet or server based storage.

Memory 910 may include volatile memory 920 and non-volatile memory 925. Computer 900 may include—or have access to a computing environment that includes—a variety of computer-readable media, such as volatile memory 920 and non-volatile memory 925, removable storage 930 and non-removable storage 935. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 900 may include or have access to a computing environment that includes output 940, input 945, and a communication connection 950. Output 940 may include a display device, such as a touchscreen, that also may serve as an input device. The input 945 may include one or more of a touchscreen, touchpad, mouse, keyboard, camera, one or more device-specific buttons, one or more sensors integrated within or coupled via wired or wireless data connections to the computer 900, and other input devices. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth, or other networks.

Computer-readable instructions stored on a computer-readable medium are executable by the processing unit 905 of the computer 900. A hard drive, CD-ROM, and RAM are some examples of articles including a non-transitory computer-readable medium such as a storage device. The terms computer-readable medium and storage device do not include carrier waves to the extent carrier waves are deemed to be transitory. For example, a computer program 915 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 900 to provide generic access controls in a COM based computer network system having multiple users and servers. Storage can also include networked storage such as a storage area network (SAN).

What is claimed is:

1. A method comprising:
a second node on a second server in a massively parallel processing (MPP) database receiving data transmitted from a first node of a first server of the MPP database over a network; and
the second node of the second server providing the data to one or more additional nodes on the second server.

2. The method of claim 1, wherein
the providing of the data from the second node to the one or more additional nodes comprises providing the data in a shared memory.

3. The method of claim 1, further comprising:
a third node on a third server in the MPP database receiving data transmitted from the first node of the first server over the network; and
the third node of the third server providing the data to one or more additional nodes on the third server.

4. The method of claim 1, further comprising:
a master host of the MPP database directing the first node to broadcast the data; and
the first node selecting the second node in response to receiving the direction to broadcast the data.

5. The method of claim 1, further comprising:
the first node on the first server randomly selecting the second node on the second server from a plurality of nodes on the second server.

6. The method of claim 1, further comprising:
by a master host of the MPP database, transmitting an instruction to the first node to broadcast the data, wherein the instruction includes an identifier of the second node; and
in response to receiving the instruction that includes the identifier of the second node, the first node on the first server randomly selecting the second node on the second server from a plurality of nodes on the second server.

7. The method of claim 6, further comprising selecting, by the master host, the second node for indication in the instruction from a plurality of nodes on the second server based on a load analysis of the plurality of nodes.

8. The method of claim 6, further comprising selecting, by the master host, the second node for indication in the instruction from a plurality of nodes on the second server using a round-robin selection algorithm.

9. A system comprising:
a first server in a massively parallel processing (MPP) database comprising:
a memory having instructions embodied thereon; and
one or more processors configured by the instructions to perform steps comprising:
receiving, at a first node of the first server, data transmitted from a second node of a second server of the MPP database over a network; and
providing the data from the first node to one or more additional nodes on the first server.

10. The system of claim 9, wherein
the providing of the data from the first node to the one or more additional nodes comprises providing the data in a shared memory.

11. The system of claim 9, further comprising:
a third server in the MPP database, comprising:
a memory having instructions embodied thereon; and
one or more processors configured by the instructions to perform steps comprising:
receiving, at a third node of the third server, data transmitted from the second node of the second server; and
providing the data from the third node to one or more additional nodes on the third server.

12. The system of claim 9, further comprising:
a master host of the MPP database, comprising:
a memory having instructions embodied thereon; and
one or more processors configured by the instructions to perform steps comprising:
directing the second node to broadcast the data; and
the second server of the MPP database, comprising:
a memory having instructions embodied thereon; and
one or more processors configured by the instructions to perform steps comprising:
selecting the first node in response to receiving the direction to broadcast the data.

13. The system of claim 9, further comprising:
the second server of the MPP database, comprising:
a memory having instructions embodied thereon; and
one or more processors configured by the instructions to perform steps comprising:
randomly selecting the first node from among a plurality of nodes on the first server.

14. The system of claim 9, further comprising:
a master host of the MPP database, comprising:
a memory having instructions embodied thereon; and
one or more processors configured by the instructions to perform steps comprising:
transmitting an instruction to the second node to broadcast the data, wherein the instruction includes an identifier of the first node.

15. The system of claim 14, wherein the steps performed by the master host further comprise:
selecting the first node for indication in the instruction from a plurality of nodes on the first server based on a load analysis of the plurality of nodes.

16. The system of claim 14, wherein the steps performed by the master host further comprise:
selecting the first node for indication in the instruction from a plurality of nodes on the first server using a round-robin selection algorithm.

17. A machine-readable medium not having any transitory signals and having instructions embodied thereon which, when executed by one or more processors of a machine, cause the machine to perform steps comprising:
receiving, from a master host of a massively parallel processing (MPP) database, an instruction to broadcast data to a plurality of nodes on a server of the MPP database;
responsive to the received instruction, selecting a node of the plurality of nodes;
transmitting the data to the node; and
refraining from transmitting the data to other nodes of the plurality of nodes.

18. The machine-readable medium of claim 17, wherein:
the selecting of the node comprises randomly selecting the node from the plurality of nodes.

19. The machine-readable medium of claim 17, wherein:
the received instruction is further to broadcast data to a second plurality of nodes on a second server of the MPP database; and
the steps further comprise:
responsive to the received instruction, selecting a second node on the second server;
transmitting to the second node; and
refraining from transmitting the data to other nodes of the second plurality of nodes.

20. The machine-readable medium of claim 17, wherein:
the received instruction identifies the node.
